(19) United States
(12) Patent Application Publication
(10) Pub. No.: US 2012/0136502 A1
(43) Pub. Date: May 31, 2012

(54) FAN SPEED CONTROL SYSTEM AND FAN SPEED READING METHOD THEREOF

(75) Inventor: Gui-Ming LIU, SHANGHAI (CN)

(73) Assignee: INVENTEC CORPORATION, TAIPEI CITY (TW)

(21) Appl. No.: 13/031,626

(22) Filed: Feb. 22, 2011

(30) Foreign Application Priority Data
Nov. 30, 2010 (CN) 201010575249.7

(51) Int. Cl. G05D 23/19

(52) U.S. Cl. 700/300

(57) ABSTRACT

A fan speed control system includes a rack and a plurality of servers disposed on the rack. The fan speed control system further includes the management module and the fan module. The management module is coupled to the servers, and the fan module is coupled to the management module for dissipating the heat from the servers. The fan module contains the fan, the speed control module, and the main control module. The speed control module is coupled to the fans. The main control module has a primary communication port. The main module which enters the interrupt sequence receives the control signals sent from the management module through the primary communication port when any one of the main modules enters the interrupt sequence. The control signal is delivered to the speed control module for reading the fan speed.

### RELATED APPLICATIONS

This application claims priority to China Application Serial Number 201010575249.7, filed Nov. 30, 2010, which is herein incorporated by reference.

### BACKGROUND

1. Field of Invention

The present invention relates to a server, and more particularly to a server with a fan.

2. Description of Related Art

In general, multiple motherboards are arranged in a rack of a server or a computer system, and elements (e.g. a central processing unit (CPU), etc.) arranged on the motherboards produce a high temperature during working. Thus, in order to avoid that the work performance of the elements is affected by the high temperature or the elements are burned out due to the high temperature, heat dissipation measures should be provided for the elements. That is, corresponding fans should be arranged near the motherboards, so as to decrease the high temperature produced by the elements on the motherboards. The fans can be managed and controlled by a fan control module after pre-reading the current rotation speed of the fans through a bus.

However, the method of pre-reading the fan rotation speed is not very effective. Particularly, when the fan rotation speed is read for many times, the case that the bus is inappropriately occupied or the case that the bus is contested may occur, which results in that a fan rotation speed value cannot be read correctly. Thus, the fan rotation speed cannot be adjusted in real time and the fan heat dissipation performance is reduced. In view of the above, a new fan speed control system is needed to correctly read the fan rotation speed value and control the fan rotation speed for decreasing the temperature.

### SUMMARY

Accordingly, an aspect of the present invention provides a fan speed control system, which can avoid occupying a bus unnecessarily so as to improve the overall transmission efficiency of the system and meanwhile can avoid the occurrence of the case that the bus is contested by multiple modules.

According to an embodiment of the present invention, the fan speed control system has a rack and multiple servers disposed on the rack. The fan speed control system further includes a management module and a plurality of fan modules. The management module is coupled to the servers. The fan modules are disposed on the rack and are coupled to the management module for dissipating heat from the servers. Each of the fan modules includes multiple fans, a speed control module and at least one main control module. The speed control module is coupled to the fans. The main control module has a primary communication port. When any one of the main control modules enters an interrupt sequence, the main control module which enters the interrupt sequence receives a control signal sent from the management module through the primary communication port. The control signal is delivered to the speed control module for reading a rotation speed value of each fan.

Another aspect of the present invention provides a fan speed control system, which can avoid occupying a bus unnecessarily so as to improve the overall transmission efficiency of the system and meanwhile can avoid the occurrence of the case that the bus is contested by multiple modules.

According to another embodiment of the present invention, a fan rotation reading method of a fan speed control system is used to read a fan rotation speed value. The method includes the following steps. At least one speed control module is initialized first. When the initialization of the spied control module is completed, it is detected whether a main control module enters an interrupt sequence. When the main control module enters the interrupt sequence, the main control module which enters the interrupt sequence receives a control signal sent from a management module through a primary communication port. The control signal is delivered to the speed control module for reading the rotation speed value of each fan.

In the fan rotation speed reading method and the fan speed control system of the above embodiments, only after a baseboard management controller gives a fan rotation speed reading command to the main control module and the main control module enters the interrupt sequence, the main control module which enters the interrupt sequence will read the fan rotation speed, but other modules will not read the fan rotation speed anymore, thereby avoiding unnecessarily occupying the bus and meanwhile avoiding the occurrence of the case that the bus is contested by multiple modules.

It is to be understood that both the foregoing general description and the following detailed description are by examples, and are intended to provide further explanation of the invention as claimed.

### -BRIEF DESCRIPTION OF THE DRAWINGS

In order to make the foregoing as well as other aspects, features, advantages, and embodiments of the present invention more apparent, the accompanying drawings are described as follows:

FIG. 1A is a schematic structural view of a fan speed control system according to an embodiment of the present invention;

FIG. 1B is a block diagram of a fan speed control system according to an embodiment of the present invention;

FIG. 2 is a flow chart of a fan rotation speed reading method according to an embodiment of the present invention; and

FIG. 3 is a flow chart of a fan rotation speed reading method according to another embodiment of the present invention.

### DETAILED DESCRIPTION

After a main control module completes the initialization of a speed control module, the main control module keeps waiting for a command given by a server baseboard management controller. Only when receiving a complete and correct fan rotation speed reading command, the main control module accesses a fan rotation speed stored in the speed control module. The main control module does not access the fan rotation speed stored in the speed control module at any other time. Another standby control module does not access the speed control module when the main control module operates normally. Therefore, it can be avoided that multiple modules access the speed control module at the same time and thus contest the bus.

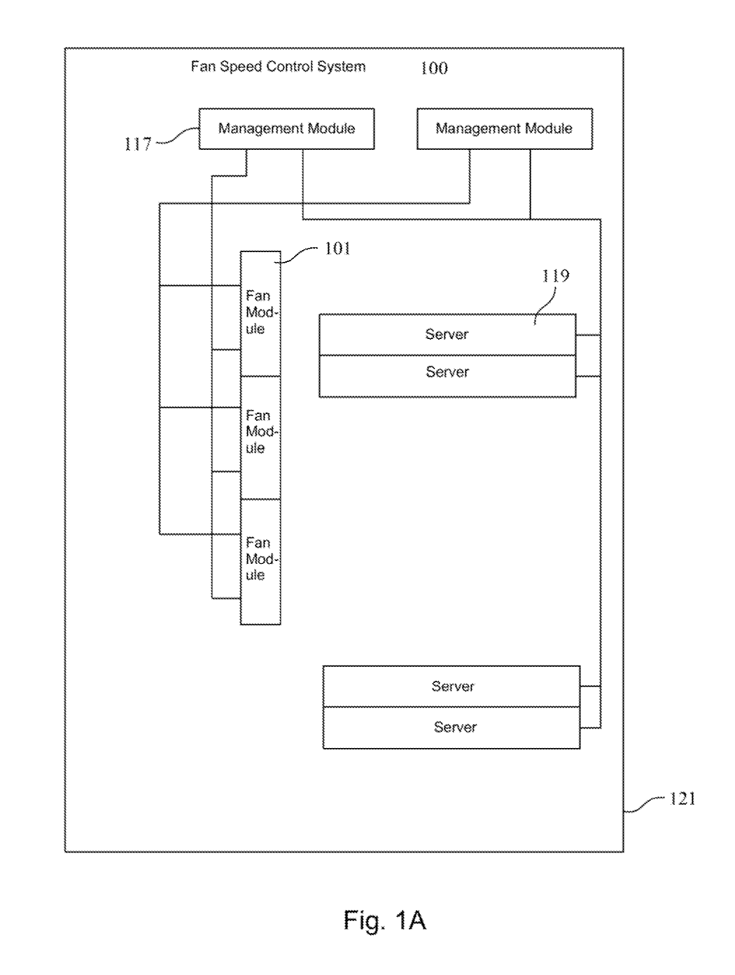

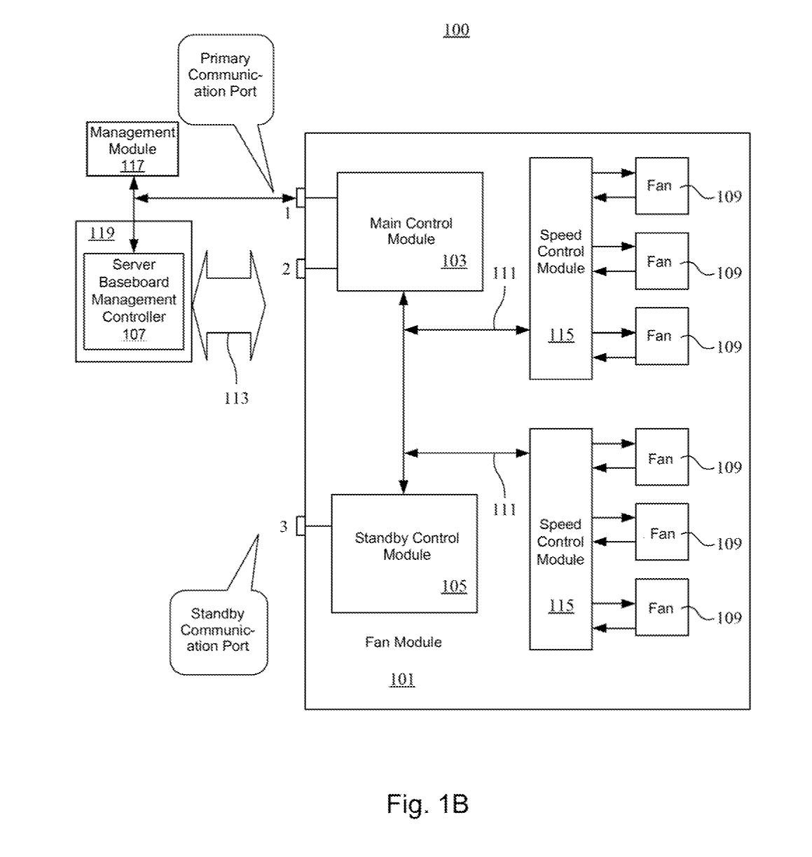

Referring to FIGS. 1A and 1B at the same time, FIGS. 1A and 1B are respectively a schematic structural view of a fan speed control system according to an embodiment of the present invention and a block diagram of the fan speed control system. The fan speed control system 100 has a rack 121 and a plurality of servers 119 disposed on the rack 121. The fan speed control system 100 includes a management module 117 and a fan module 101. The to management module 117 is coupled to the servers 119. The fan module 101 is disposed on the rack 121 and is coupled to the management module 117 for dissipating heat from the servers 119, thereby avoiding that apparatuses on the fan speed control system 100 are damaged due to an overhigh temperature of the fan speed control system 100.

Each server 119 has a server baseboard management controller 107. The management module 117 controls the server baseboard management controller 107 to make it read a temperature value of the server 119. The server baseboard management controller 107 is also responsible for monitoring various states of the server 119, such as monitoring and recording the temperature of the server 119 or recording various errors in transmission, so that it is convenient for a monitoring operator to manage, control and repair the server or so that a basis is provided for the improvement of the server 119. The server baseboard management controller 107 mainly includes a microcontroller and a firmware which is embedded in the server baseboard management controller, and the server baseboard management controller 107 can act as an interface between a management software of the fan speed control system and a platform management hardware to work across different firmware and hardware platforms. For example, the server baseboard management controller 107 can initiatively provide functions such as monitoring a system state of the software or hardware of a computer system, recording an event log, controlling system reboot, automatically generating an alarm for an event and automatically performing a system control (e.g. power-off). Furthermore, the server baseboard management controller can be used to monitor an abnormal system voltage, temperature, fan speed in the computer system in real time and determine whether the monitored data is beyond a preset range.

A second bus 113 is electrically connected between the server baseboard management controller 107 and the fan module 101 for transferring a command and data sent by the server baseboard management controller 107 and controlling the rotation speed of the fans 109. The second bus 113 can be an RS 485 bus or a transmission line of some other type. In general, the second bus 113 is connected to a primary communication port 1. If the primary communication port 1 is faulty, the second bus 113 can be connected to a standby communication port 2 or a standby communication port 3 in a manual plug-in and pull-out manner.

The fan module 101 includes the fans 109, a speed control module 115 and a main control module 103. The speed control module 115, e.g. an ADT7490 chip, is coupled to each fan 109. The speed control module 115 and the main control module 103 both transfer a command and data through a first bus 111, so as to provide related information such as the fan rotation speed of the fan module 101, wherein the first bus 111 can be an inter-IC (I²C) bus or a transmission line of some other type.

The main control module 103 has a primary communication port and a standby communication port (2) for transferring data and a command. When any one of the main control modules 103 enters an interrupt sequence, the main module 103 which enters the interrupt sequence receives a control signal sent from the management module 117 through the primary communication port, and delivers the control signal to the speed control module 115 for reading the rotation speed value of each fan 109. The speed control module 115 returns the rotation speed value of each fan 109 to the management module 117. The management module 117 adjusts an actual rotation speed value of each fan 109 according to a temperature value of the server 119 and the rotation speed value.

The fan module 101 further includes a standby control module 105 which has a standby communication port. When the server 119 is booted, the main control module 103 initializes the speed control module 115, and after a first predetermined time period (e.g. tens of seconds), the standby control module 105 initializes the speed control module 115 instead. It should be particularly noted that one of the main control module 103 and the standby control module 105 enters the interrupt sequence and accesses the speed control module 115 for reading the fan rotation speed, and the other one stays in an idle state and does not access the speed control module 115, thereby avoiding that the two single-chip microcomputers contest the first bus 111. The communication ports can be replaced with each other in a manual plug-in and pull-out manner, and various serial ports can also be replaced with each other automatically through a circuit. Since a standby communication port for replacement exists, when one of the serial ports is faulty, it can be replaced by some other communication port, so that the command and data can be transmitted continuously and the fan speed control system 100 can work normally.

More particularly, when the main control module 103 cannot receive the control signal sent from the management module 117, the standby control module 105 receives the control signal sent from the management module 117 through the standby communication port, and delivers the control signal to the speed control module 115. The case that the main control module 103 cannot receive the control signal sent from the management module 117 refers to the case that the main control module 103 does not respond within a second predetermined time period (e.g. tens of seconds) after the management module 117 sends the control signal to the main control module 103.

In the fan speed control system 100 of this embodiment, each fan module 101 can control six fans 109, and each server baseboard management controller 107 can control five fan modules 101. This embodiment only illustrates some fans 109 and some fan modules 101 by example.

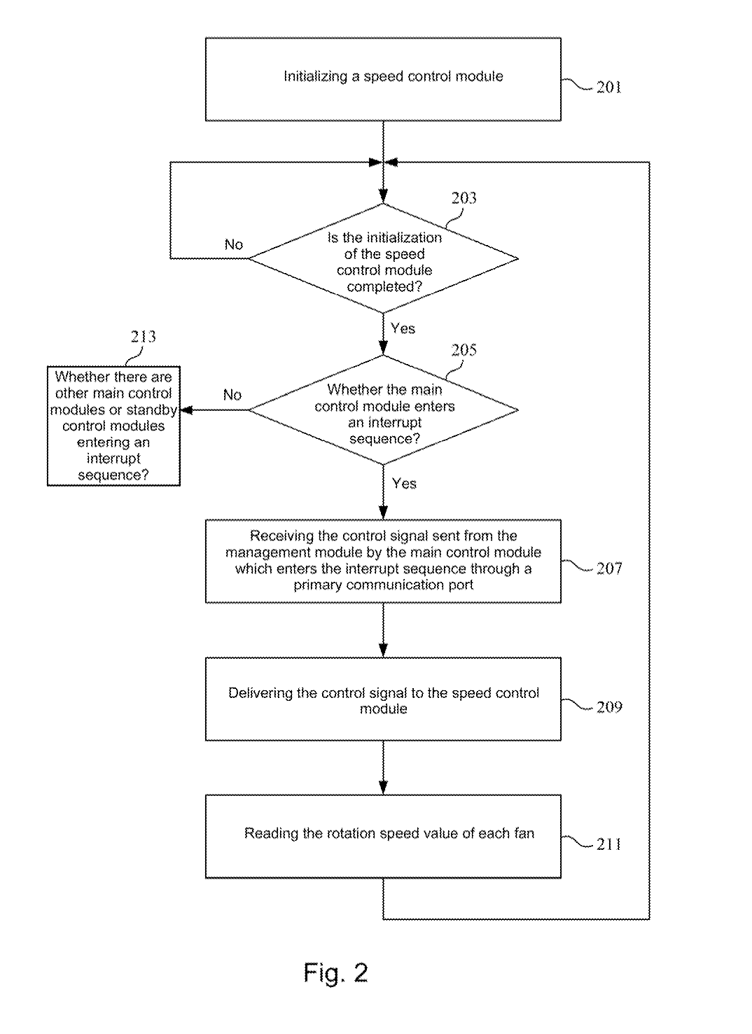

Referring to FIG. 2, it is a flow chart of a fan rotation speed reading method according to an embodiment of the present invention. The fan rotation speed reading method aims to read a fan rotation speed of at least one fan speed control system. The method first initializes at least one speed control module (step 201). For example, it is first determined which main control module or standby control module has a primary communication port or standby communication port that is working normally, and then the chip is initialized by the main control module or standby control module having the primary communication port or standby communication port that is working normally.

If the initialization of the speed control module is not completed, the method continues to wait until the initialization is completed. When the initialization of the speed control module is completed (step 203, which is a sub-step), the method continues to detect whether the main control module enters an interrupt sequence (step 205). When the main control module enters the interrupt sequence, the main control module which enters the interrupt sequence receives a control signal sent from a management module through a primary communication port (step 207), and delivers the control signal to the speed control module (step 209) for reading the rotation speed value of each fan (step 211). In addition, if it is found in step 205 that the main control module is not interrupted, the method continues to detect whether there are other main control modules or controlled modules entering the interrupt sequence (step 213).

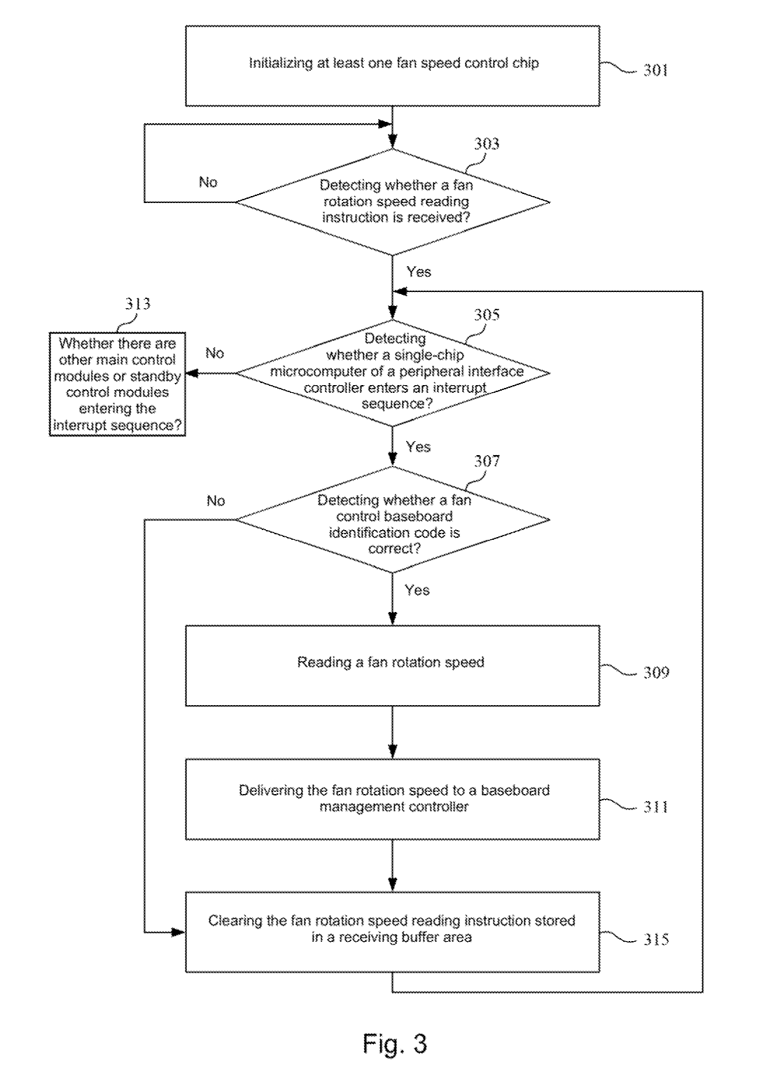

Referring to FIG. 3, it is a flow chart of a fan rotation speed reading method according to another embodiment of the present invention. In the fan rotation speed reading method of this embodiment, steps 301, 303, 305, 309 and 313 are respectively the same as the steps 201, 203, 205, 211 and 213 in the embodiment of FIG. 2. However, additional steps are added to this embodiment for reading a fan rotation speed.

When the main control module enters the interrupt sequence, the method continues to detect whether a fan module identification code received by the main control module which enters the interrupt sequence is correct (step 307). If it is found in step 307 that the fan module identification code is correct, the fan module identification code is an identification code of the main control module, which is the same as a fan module identification code contained in a fan rotation speed reading instruction and represents that the current fan module is an object which the fan rotation speed reading instruction is directed to. In this case, the method continues to read the fan rotation speed. At the same time, other main control modules or standby control modules stay in an idle state and do not occupy the bus for accessing the fan rotation speed stored in the speed control module.

More particularly, the fan rotation speed reading instruction contains the fan module identification code (the value is 0-7), a module identification code (the value is 1-255) and a fan number (the value is 1-255). The fan speed control system in this embodiment of the present invention includes a plurality of (e.g. five) fan modules, wherein each fan module includes a plurality of (e.g. two) main control modules and each fan module can control several groups of fans (e.g. six groups). Thus, the fan module identification code is needed to select one from a plurality of fan modules, then the module identification code is used to select one from a plurality of main control modules or standby control modules of the selected fan module, and finally a fan is selected for reading the fan rotation speed thereof.

Then, the read fan rotation speed value is delivered to a server baseboard management controller (step 311). For example, if the delivered rotation speed value is 0, it represents that the rotation speed is about 1,000 revolutions. If the delivered rotation speed value is 100, it represents that the rotation speed is about 5,500 revolutions. In addition, if the main control module fails to read the fan rotation speed, 0 is delivered to the server baseboard management controller.

After the fan rotation speed value is delivered to the server baseboard management controller, data stored in a receiving buffer area of the main control module is cleared (step 315), so that the fan rotation speed reading instruction and the fan rotation speed instruction stored in the buffer area are a real-time instruction and a real-time rotation speed, so as to avoid that old and new fan rotation speed values are mixed together or the fan rotation speed is repeatedly read because the old reading instruction is not cleared.

In the fan rotation speed reading method and the fan speed control system of the above embodiments, only when the management module or the baseboard management controller gives the fan rotation speed reading command to a certain main control module or standby control module and the main control module or standby control module already enters the interrupt sequence, the main control module or standby control module which enters the interrupt sequence reads the fan rotation speed, but the other module will not read the fan rotation speed, thereby avoiding unnecessarily occupying or contesting the bus and meanwhile avoiding the occurrence of the case that the bus is contested by a plurality of modules.

Although the present invention has been disclosed with reference to the above embodiments, these embodiments are not intended to limit the present invention. It will be apparent to those skilled in the art that various modifications and variations can be made without departing from the scope or spirit of the present invention. Therefore, the scope of the present invention shall be defined by the appended claims.

What is claimed is:

1. A fan speed control system, having a rack and a plurality of servers disposed on the rack, wherein the fan speed control system further comprises:
a management module coupled to the servers; and
a plurality of fan module disposed on the rack and coupled to the management module for dissipating heat from the servers, wherein each of the fan modules further comprises:
a plurality of fans;
a speed control module coupled to each of the fans; and
at least one main control module having a primary communication port, wherein, when any one of the main control modules enters an interrupt sequence, the main control module which enters the interrupt sequence receives a control signal sent from the management module through the primary communication port, and delivers the control signal to the speed control module for reading a rotation speed value of each of the fans.

2. The fan speed control system of claim 1, wherein the speed control module returns the rotation speed value of each of the fans to the management module, and the management module adjusts an actual rotation speed value of each of the fans according to a temperature value of the servers and the rotation speed value.

3. The fan speed control system of claim 1, wherein the fan module further comprises a standby control module which has a standby communication port, wherein, when the main control module cannot receive the control signal sent from the management module, the standby control module receives the control signal sent from the management module through the standby communication port, and delivers the control signal to the speed control module.

4. The fan speed control system of claim 3, wherein, when the server is booted, the main control module initializes the speed control module, and after a first predetermined time period, the standby control module initializes the speed control module.

5. The fan speed control system of claim 3, wherein the main control module without receiving the control signal sent from the management module is meaning that the main control module does not respond within a second preset time period after the management module sends the control signal to the main control module.

6. The fan speed control system of claim 1, wherein each of the servers has a server baseboard management controller, and the management module controls the server baseboard management controller to make it read a temperature value of the server.

7. A fan rotation speed reading method of a fan speed control system, for reading a fan rotation speed value, comprising:
initializing at least one speed control module;
detecting whether a main control module enters an interrupt sequence when the initialization of the speed control module is completed; and
receiving a control signal sent from the management module by the main control module which enters the interrupt sequence through a primary communication port when the main control module enters the interrupt sequence, and delivering the control signal to the speed control module for reading the fan rotation speed value.

8. The fan rotation speed reading method of claim 7, further comprising continuing to detect whether a fan module identification code received by the main control module which enters the interrupt sequence is correct when the main control module enters the interrupt sequence.

9. The fan rotation speed reading method of claim 7, further comprising delivering the read fan rotation speed value to a server baseboard management controller.

10. The fan rotation speed reading method of claim 9, further comprising clearing data stored in a receiving buffer area of the main control module after delivering the fan rotation speed value to the server baseboard management controller.
